(19) United States
(12) Patent Application Publication
(10) Pub. No.: US 2013/0137490 A1
(43) Pub. Date: May 30, 2013

(54) APPARATUS FOR INDICATING THE FILLING LEVEL OF A DRINKING VESSEL

(71) Applicant: bluebox Promotion GmbH, Worms (DE)

(72) Inventor: Alexander Quehl, Worms (DE)

(73) Assignee: bluebox Promotion GmbH, Worms (DE)

(21) Appl. No.: 13/683,410

(22) Filed: Nov. 21, 2012

(30) Foreign Application Priority Data
Nov. 25, 2011 (DE) 102011087119.5

(51) Int. Cl. G01F 23/00; G08B 5/36; H04B 1/02; H04W 88/02; G01F 23/20; G01F 23/296

(52) U.S. Cl. CPC G01F 23/00; G01F 23/20; G01F 23/296; H04B 1/02; H04W 88/02; G08B 5/36
USPC 455/567; 73/290 R; 73/293; 73/296; 73/290 V; 455/91; 340/815.4

(57) ABSTRACT

The invention relates to an apparatus on which a drinking vessel may be placed, in particular an apparatus which provides information, wherein the information is connected with the drinking vessel. An apparatus for indicating the filling level of a drinking vessel comprises a placement device on which the drinking vessel is placed, a detection device for detecting the filling level of the drinking vessel (200), and a display element which displays the detected filling level.

### FIELD

The invention relates to an apparatus on which a drinking vessel may be placed, in particular to an apparatus which provides information, wherein the information is associated with the drinking vessel.

### BACKGROUND

Drinks are served to guests in a plurality of events, such as club events, parties and receptions, or also in restaurants or bars. The drinking vessels used in this connection, such as glasses, paper cups or cans, must be collected promptly to clean and reuse them or discard them professionally, for example. However, for this purpose it is necessary to first determine whether a drinking vessel is empty. In order to answer the question of whether it makes sense to offer a new beverage to a guest, it is also necessary to determine the current filling level of his or her drinking vessel.

Such determinations are typically made by the wait staff. For example, it is in the responsibility of the wait staff to judge when a guest has finished his/her beverage to offer him/her promptly a new beverage and/or collect empty glasses, paper cups or cans sitting around.

However, this task is impeded because it is often difficult for the wait staff to judge whether a drinking vessel is still full, half full or already empty. For example, it is difficult to judge the filling level of a drinking vessel in poorly lit bars or clubrooms. It is almost impossible to make such a differentiation when drinking vessels, such as cans, are only partially transparent or opaque.

Therefore, there is the problem that the wait staff either offers a new beverage to a guest even though the guest still has a beverage or does not offer a new beverage to a guest even though the guest would like to have a new beverage. The wait staff also has to make a close-up inspection of every drinking vessel when removing drinking vessels to check in said poorly lit bars or clubrooms and/or in the case of only partially transparent or opaque drinking vessels whether the drinking vessel is actually empty. This leads to the above mentioned problems, such as a delayed return or disposal of drinking vessels, which has to be compensated by an increased supply of drinking vessels. A plurality of drinking vessels sitting around may also render an overall appearance of an event detrimental. In addition, drinking vessels sitting around are a safety concern since it may happen that they drop to the floor where they break and/or a guest trips over them.

There is therefore a need to provide information about one or more drinking vessels, said information being accessible and judgeable in the easiest way possible.

An aspect of the present application relates to an apparatus for indicating the filling level of a drinking vessel. The apparatus comprises a placement device on which the drinking vessel is placed. Such a placement device may be made as a round plate of metal, e.g., of aluminum or stainless steel, or of a synthetic material, e.g. of silicone. Alternatively, the placement device may be angular, e.g. rectangular, and have a length which is twice as long as the width or it may be square. The placement device may also be provided for one or more drinking vessels. For example, the placement device may be provided for putting down a glass and/or a can. In addition, the apparatus may have a detection device for detecting the filling level of the drinking vessel and a display element which displays the detected filling level. In this case, the display element may be adapted to display the filling level of the drinking vessel by means of a light source. The light source may be an LED, for example. The light source typically emits light in the visible frequency range.

In an embodiment, the brightness and/or color and/or flashing frequency of the light from the light source may be changed according to the filling level of the drinking vessel. For example, a full drinking vessel may be indicated by a blue light and an empty drinking vessel may be indicated by a red light. The transition between blue and red lights may be made in steps or be continuous. The light source may also flash when the drinking vessel is empty, i.e. the light is only emitted during certain time intervals.

Moreover, the detection device may be adapted to detect a current weight of the drinking vessel and to determine the filling level of the drinking vessel from the detected weight of the drinking vessel. Here, it is possible to consider the weight of the drinking vessel which is unfilled and the weight of the drinking vessel when it is in a fully filled condition. For example, the current weight may be divided by, or may be related to, the difference between the fully filled drinking vessel and the empty drinking vessel. The resulting value is a possible measure for the filling level.

The detection device may comprise a balance or scales which is adapted to detect the current and/or empty/full weight of the drinking vessel. The balance may be operated mechanically or electronically, for example. The detection unit may possibly comprise a contact switch which is activated when the drinking vessel is put down and a minimum weight force is exceeded and which returns to its rest position when the weight force is reduced, i.e. when the drinking vessel is emptied, wherein the display device may change the light or the light color or the flashing frequency, as described above, according to the filling level and/or the position of the contact switch.

The balance may comprise a strain gauge, SG, and the SG may detect a distortion of a bending element of the balance on which the SG is provided. A weight force or a weight bearing down on the SG may be determined from the distortion. The SG may consist of a piezo-resistive material, for example.

When the drinking vessel is made of a material that conducts an electric current, e.g. a tin can, the detection device may determine the type of the drinking vessel by passing e.g. an electric current through the drinking vessel and measuring the electrical resistance.

By way of alternative or supplement, the detection device may be adapted to detect ultrasonic waves which are scattered by the beverage in the drinking vessel. For this purpose, e.g. ultrasonic waves may be emitted through the bottom of the drinking vessel and the reflected ultrasonic waves may be detected. Since sound waves are partially absorbed by the liquid in the drinking vessel, the filling height may be determined from the intensity of the detected sound waves.

When at least part of the drinking vessel consists of a transparent or semi-transparent material and the detection device is adapted to detect light which is scattered, and also partially absorbed, by the beverage in the drinking vessel, the filling height of the drinking vessel may be determined from the detected light intensity. The scattered light may be emitted from the light source (before it is scattered).

The apparatus may comprise an electric energy storage and/or a charging device, wherein the charging device may be adapted to recover electrical energy from a placement process and to supply this energy to the energy storage. For example, the placement device may comprise piezoelectric material which converts the pressure that the drinking vessel produces while the drinking vessel is put down into electrical power.

The apparatus may comprise a transmitter. The transmitter may be adapted to receive information from the detection device and to transmit it. For example, the transmitter may comprise a radio transmitter and may be adapted to transmit the availability of a drinking vessel on the placement device or the filling level of the drinking vessel via radio to a central unit.

The placement device may comprise a means for centering the drinking vessel. The means for centering the drinking vessel may be an elevation on the surface of the placement device. The elevation may be made so as to positively fit into a corresponding recess in a drinking vessel.

The apparatus may be made of one material or several materials which is/are resistant to heat. For example, the material/materials may be water-resistant up to approximately 70° and therefore the apparatus is machine-washable.

Incoming calls to a cell phone to which the apparatus is assigned may be signalized by a flashing of the apparatus. For example, the apparatus may comprise a radio receiver which may identify an incoming call for a cell phone positioned in the vicinity of the apparatus.

A further aspect of the present application relates to an apparatus for identifying a drinking vessel. The apparatus comprises a placement device on which the drinking vessel may be placed. The apparatus also comprises a display element which indicates whether the drinking vessel is on the placement device. For example, when a drinking vessel is on the placement device, light of a predetermined color and/or of a predetermined light-on duration/frequency may be emitted from a light source and, when no drinking vessel is on the placement device, either no light or light of another predetermined color and/or of another predetermined light-on duration/frequency may be emitted.

The apparatus may be equipped with a communication device which possibly transmits a signal to a system in response to a request by a user, wherein the signal signalizes that the user places an order for a beverage. The apparatus may be equipped with a storage device storing what beverages the user has ordered. The apparatus may be equipped with a read-out device from which the stored data may be read out. The communication device and the read-out device may be connected in wireless or wire-bound fashion. Alternatively, the read-out device may indicate a corresponding bar code which may be read out using a bar code reader. The bar code may be two-dimensional.

A further aspect of the present application relates to a system which comprises a plurality of placement devices on which drinking vessels may be placed and a plurality of detection devices for detecting the filling level of the drinking vessels. The placement devices may be the placement devices described above. In addition, the system comprises a display device, wherein the display device is adapted to receive signals from the plurality of apparatuses and to display the filling level of at least one drinking vessel. The communication may be wire-bound or wireless. For example, the communication may be made via radio. The radio communication may be made via Bluetooth, for example. It is thus possible to assess or display the information of several apparatuses on a central unit. For example, a central display may visualize which tables have empty drinking vessels. This information may be utilized, for example, to plan or modify/optimize the wait staff's routes through an event location to eliminate an imbalance in the beverage supply, for example. The information may also be used to find out whether an event location is prepared/planned well since information is available as to how many beverages are taken and where they are taken. This information may show, for example, whether the position of tables has been chosen well since e.g. a table where only very few or no drinks are taken might be located at a place that does not really invite to stay.

A further aspect of the present application refers to a drinking vessel table mat, such as a bar mat. The bar mat may comprise a bar mat base which consists of an at least partially transparent material. Furthermore, the bar mat may comprise a plurality of illuminants, wherein the illuminants are attached to the bar mat base in such a way that at least part of the light emitted by the illuminants shines through the transparent material of the bar mat base. The illuminants may be controlled by a pressure sensor provided on the bar mat. For example, the bar mat may be activated when one or more drinking vessels are placed on the pressure sensor of the bar mat and may automatically be deactivated when no signal is received from the pressure sensor for a predetermined period of time. An on-button and/or off-button may also be provided. The illuminants may be LEDs and may be supplied with current by a power source, e.g. one or more batteries or accumulators.

### BRIEF DESCRIPTION OF THE DRAWINGS

In order to better understand the invention, the below description is advantageously read in conjunction with the enclosed illustrations, wherein:

FIGS. 1a-1r show apparatuses which provide information, wherein the information is correlated with a drinking vessel;

FIG. 2 shows an apparatus which illustrates the filling level of a drinking vessel;

FIG. 3 shows an apparatus which rotates a drinking vessel placed on a placement device about a vertical axis;

FIG. 4 shows an apparatus which provides information, wherein the information is in conjunction with a drinking vessel; and

FIGS. 5 to 7 show diagrammatic drawings of a system for indicating information with respect to several drinking vessels.

### DETAILED DESCRIPTION

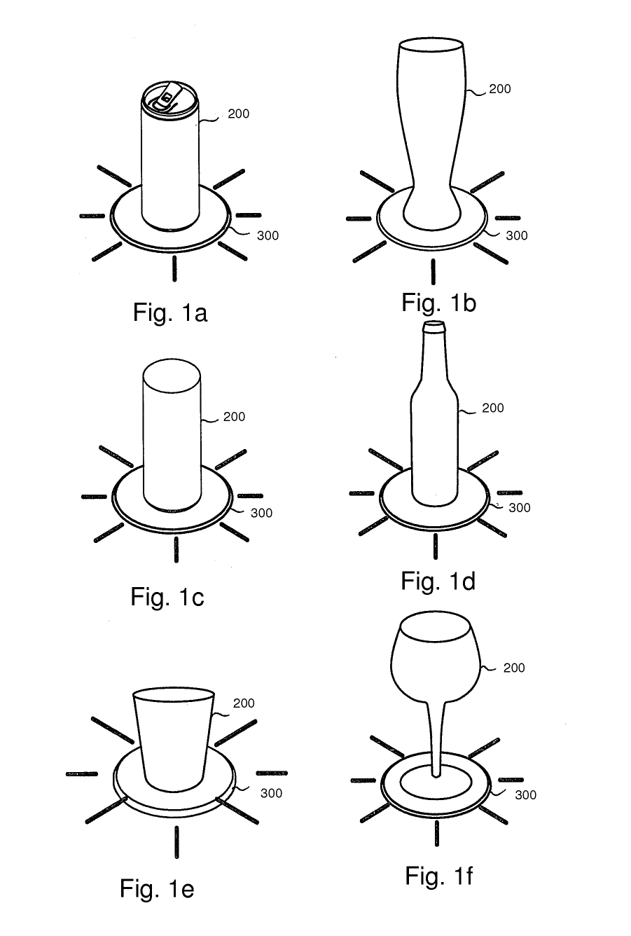

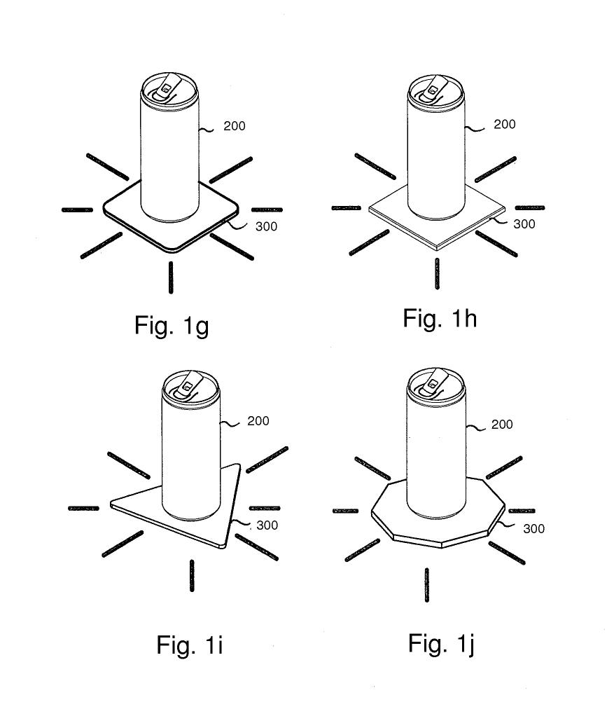

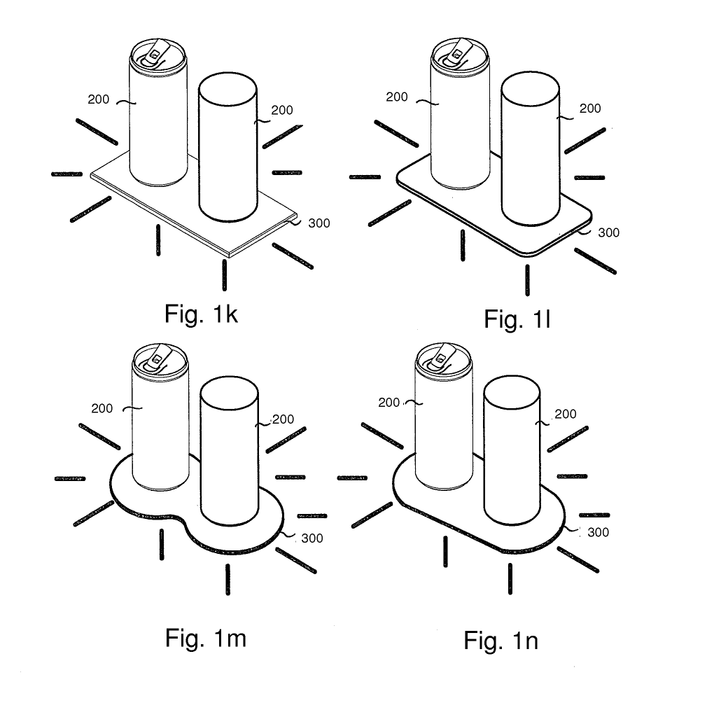

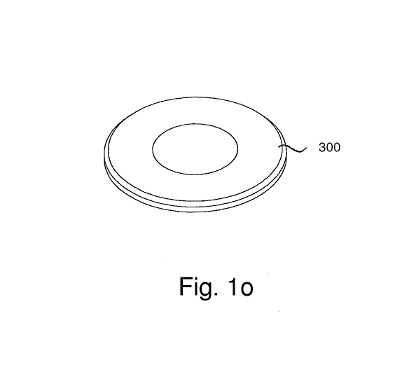

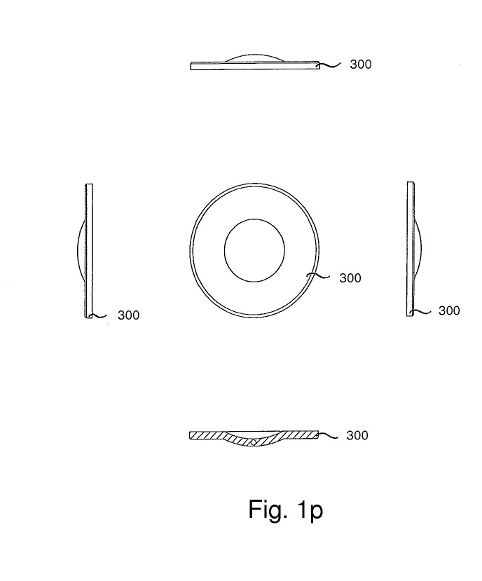

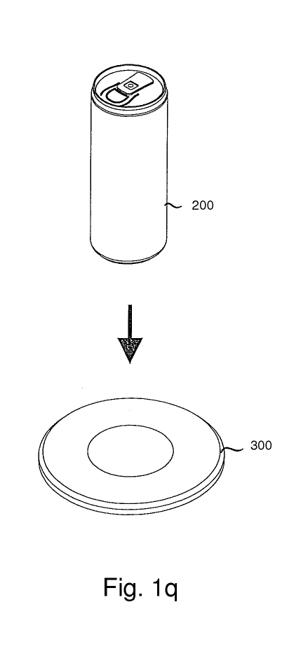

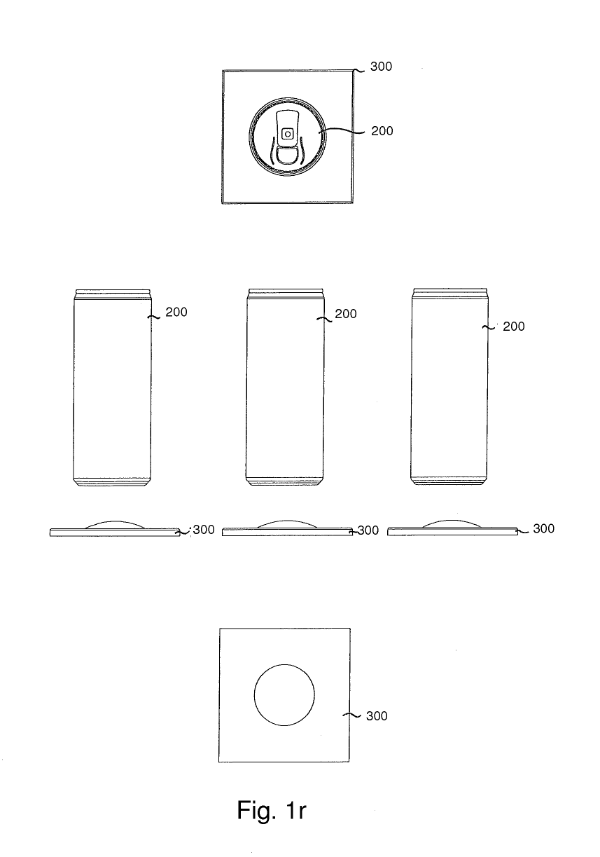

FIGS. 1a to 1r show apparatuses which provide information, wherein the information is in conjunction with a drinking vessel. For example, some of the apparatuses are adapted to show whether a drinking vessel 200 is on a placement device 300. The drinking vessel may be a can, a mug, a glass, for example, and may have various shapes, as exemplified in FIGS. 1a to 1f. When the drinking vessel 200 is placed on the placement device 300, the placement device 300 may show this e.g. on a display element. For example, the display element may start to give light or to vibrate or produce an acoustic signal.

For example, the placement device 300 may give light of a predetermined color. The color may be blue and the light may be produced by an LED. The placement device 300 may be round, triangular or rectangular, e.g. square, as exemplified in FIGS. 1g to 1j. One or more drinking vessels 200 may be placed on the placement device 300. For example, a can and a glass may be placed on the placement device 300, as exemplified in FIGS. 1k to 1n.

Alternatively or additionally, the apparatus may be adapted to indicate whether or not one or more drinking vessels 200 which have been placed on a placement device 300 are empty. When a drinking vessel 200 is placed on the placement device 300, the placement device 300 may start to give light. For example, the placement device 300 may give light of a predetermined color. The color may be blue and the light may be produced by an LED. The placement device 300 may be round or rectangular, e.g. square. When the drinking vessel is empty, the placement device 300 may start to give light of a color other than the predetermined color, e.g. red. This may signalize that the drinking vessel 200 is empty.

The placement device 300 may comprise a means for centering the drinking vessel, as shown in FIGS. 1o to 1r. The means for centering the drinking vessel may be an elevation on the surface of the placement device. The elevation may be made so as to positively fit into a corresponding recess in a drinking vessel. The shape of the elevation may be formed like part of a sphere, e.g. the elevation may be substantially semi-spherical.

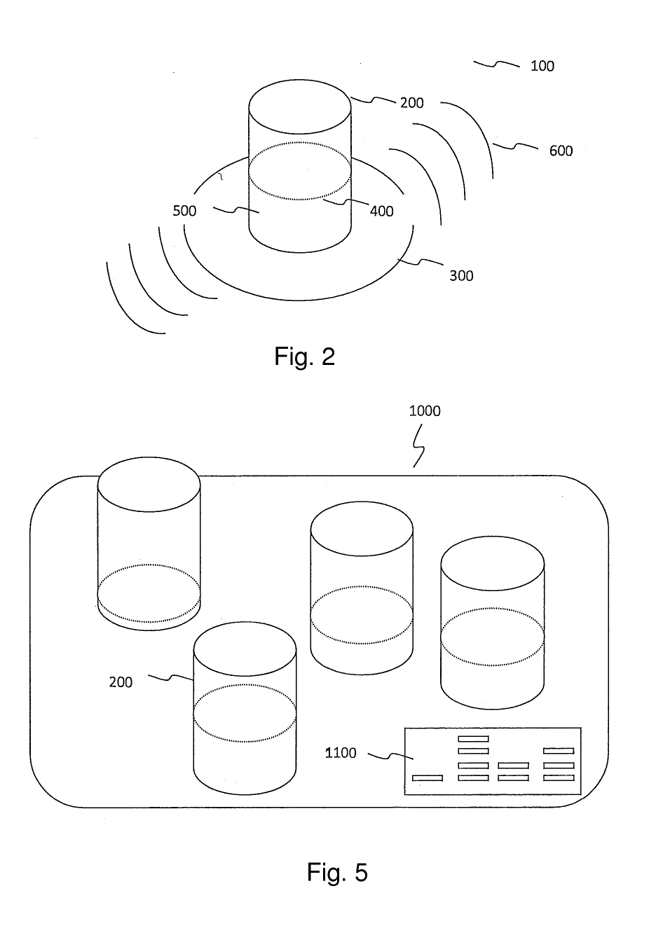

Alternatively or additionally, the apparatus 100 may be adapted, as shown in FIG. 2, to indicate the filling level of a drinking vessel 200. The apparatus 100 comprises a placement device 300 having a surface which faces the drinking vessel 200 and on which the drinking vessel 200 may be placed. In an alternative embodiment, a recess is provided in the apparatus 100 as a placing device, wherein the recess is adapted to at least partially accommodate the drinking vessel 200. The surface of the placement device 300, which faces the drinking vessel, may be round or angular. The surface of the placement device 300 is preferably greater than the surface of the side of the drinking vessel 200 which faces the placement device 300 when the drinking vessel 200 is placed on the placement device 300.

The surface of the placement device 300 may be planar. In an alternative embodiment, the surface of the placement device 300 may have a circumferential elevation adapted to the shape of the drinking vessel 200, said elevation being adapted to center the drinking vessel 200 with respect to a certain position when putting it down.

The surface region of the placement device 300, which substantially extends parallel to the bottom of the drinking vessel 200 outside the recess, may extend at a predetermined distance substantially parallel to the bottom of the drinking vessel 200. In an alternative embodiment, this surface region of the placement device 300, which extends outside the elevation, may extend substantially at the bottom height of the drinking vessel 200.

The apparatus 100 comprises a detection device for detecting the filling level of the drinking vessel 200. The expression “filling level” may be understood to mean a value indicating to what level, e.g. in percent, a drinking vessel 200 is filled. A half-full drinking vessel 200 would thus have a filling level of 50% or, if the filling level is standardized to be 1, a filling level of 0.5. Alternatively, the filling level may also be indicated in relation to an arbitrarily chosen basic value, e.g. by assigning at a given point in time a basic value to a drinking vessel filled in any way, e.g. the basic value 1. An increase in the filling amount could then be expressed as an increase in the basic value and a decrease of filling amount could then be expressed by a reduced basic value.

Depending on whether the filling level is to be determined absolutely or relatively and depending on the accuracy requirements which have to be complied with in the determination, the detection device may be adapted to use one or a combination of the technical procedures described below.

A first procedure determines the weight of the drinking vessel 200. The weight of the drinking vessel 200 may constantly vary by removing or adding liquid filling amount, such as a beverage, or by removing or adding non-liquid filling amount, such as ice cubes. A current weight of the drinking vessel 200 is thus a weight at a current point in time, namely at the point in time at which the detection device determines the weight of the drinking vessel 200. The current weight of the drinking vessel 200 comprises the empty weight of the drinking vessel 200 and, if a liquid and/or a solid filling amount is available, the weight of the liquid filling amount and/or the weight of the solid filling amount. In order to determine the current weight of the drinking vessel 200, the detection device may comprise a balance or scales. The balance may measure a deformation of an elastic element. For example, the elastic element is deformed when it is fully or partially loaded with the current weight of the drinking vessel. The deformation may then be measured by means of strain gauges which are attached to the elastic element. When there is an at least approximate knowledge of the elasticity parameters of the elastic element, the current weight may be calculated from the measured deformation.

When there is no drinking vessel 200 on the placement device 300, the balance 300 may be calibrated. For this purpose, the detection device must first determine whether there is a drinking vessel 200 on the placement device 300. In order to determine this, the detection device may detect, for example, whether e.g. an electrical resistance between two contacts on the placement device 300 corresponds to a predetermined value. If the electrical resistance is below the predetermined value, it may be concluded, for example, that there is a current-conducting drinking vessel 200 on the placement device 300. Alternatively, the calibrating process may be started automatically, e.g. shortly after strongly loading the balance, wherein “strongly loading the balance” is understood to mean a load that exceeds a certain value, as would be produced e.g. by putting down a fully filled drinking vessel 200. For example, a fully filled drinking vessel 200 or an equally heavy object may be pressed on the placement device 300 for a short period of time and then be removed again to calibrate the balance. Alternatively, the calibration process may also be started automatically when a weight measured by the balance is reduced very rapidly in a short time, i.e., when a certain weight decrease rate is exceeded, which eliminates the emptying of the drinking vessel 200 by means of a straw, for example, and suggests that the drinking vessel 200 has been removed from the placement device 300.

The placement device 300 may likewise be calibrated in such way that, when a fully filled drinking vessel 200 is placed on the placement device 300, the placement device 300 stores the signals of the balance to subsequently use them as a reference. Here, the calibration process may be started by actuating a switch, for example. Alternatively, the above described mechanisms may be used suitably for starting the calibration process, it being clear that the drinking vessel 200 or a weight equal to the drinking vessel 200 must be on the placement device 300 when the calibration process starts.

A second procedure determines the filling height of the drinking vessel 200. The filling height of the drinking vessel 200 may be determined inter alia from the knowledge of the position of the surface 400 which separates the content 500 of the drinking vessel 200 from the ambient air. It is at this separating surface 400 where the effect occurs that a reflection of electromagnetic waves takes place on account of the different optical refractive indices of the content 500 of the drinking vessel 200 and the ambient air. Likewise there is the effect that acoustic waves are reflected at the transition from the content 500 of the drinking vessel 200 to the ambient air. For example, if light or ultrasonic waves are passed through the drinking vessel towards the separating surface 400, part of the waves is reflected at the separating surface. These reflected waves may then be detected by means of a detection device which is provided e.g. underneath the drinking vessel bottom, e.g. as a member of the placement device 300.

The filling height of the drinking vessel 200 may be determined in various ways. On the one hand, the filling height may be determined from the detected reflected portion which penetrates the bottom of the drinking vessel since part of the waves is absorbed, wherein the more waves are absorbed, the greater is the distance which the waves travel through the content 500. It is also possible to emit the waves in such a way that they impinge on the separating surface 400 at a predetermined angle. The greater the filling height, the greater is the number of reflected waves that impinge instead on the bottom of the drinking vessel 200 on the lateral margin or boundary area of the drinking vessel 200 and leave the drinking vessel 200 through the lateral margin. As a result, they may no longer be detected by the detection device underneath the bottom of the drinking vessel 200. It is here also possible to determine the filling height from the detected reflected portion. It is also possible to consider both effects simultaneously to increase the accuracy of the detection device.

A third procedure determines the empty weight and the weight of the fully filled drinking vessel 200. For this purpose, the detection device may detect whether a drinking vessel 200 is on the placement device. When a drinking vessel 200 is on the placement device 300, the detection device may determine the type of the drinking vessel 200, e.g. the detection device may determine whether this vessel is a can, a glass or a paper cup. For example, the detection device may apply an electrical potential to two points of the drinking vessel 200 and determine the electrical resistance of the drinking vessel 200. Provided that a predetermined resistance value is known for every drinking vessel type, the drinking vessel type may be determined from the measured resistance value. When the empty weight is available for each drinking vessel type, the empty weight of the drinking vessel 200 may be determined from the knowledge about the drinking vessel type. The weight of the fully filled drinking vessel 200 may likewise be determined when the drinking vessel type is known. For example, the empty weight and the weight of the fully filled drinking vessel 200 of each drinking vessel type may be known and stored in a table in a memory, e.g. on the detection device.

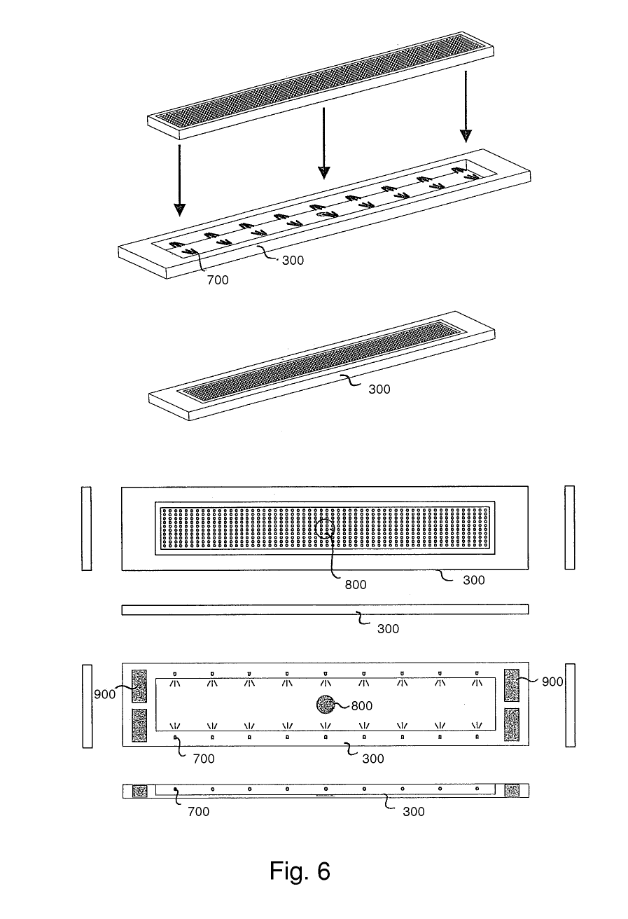

The filling amount may be displayed by means of a display element of a display device. The display device may be a digital display. The display element may comprise a light source. The display element may thus display different filling levels by light 600 of different colors. In addition, the display element may display different filling levels by light 600 of different intensity. Furthermore, the display element may display different filling levels by light pulses 600 of different duration/frequency. It is also possible to combine different colors, light intensities and/or light pulse durations/frequencies to display the filling level. In addition, the display element may have a wireless or wire-bound communication connection to a central unit where different filling levels of one or more drinking vessels may be displayed, as described e.g. in connection with FIG. 5 and FIG. 6.

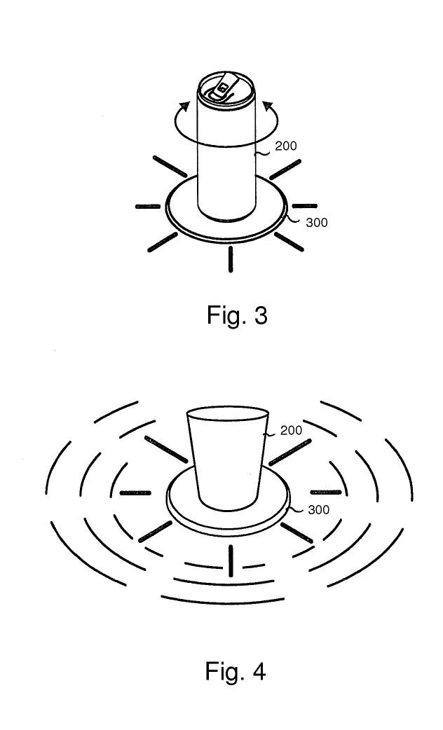

Alternatively or additionally to the above described features, the placement device 300 may consist of two or more elements. Here, a first element may be rotatably mounted in relation to a second element, as shown in FIG. 3. For example, the placement device 300 comprises a second element which rests on a table plate, for example, and a first element which receives the drinking vessel 200. In a preferred embodiment, it is possible to automatically drive the movement of the first element in relation to the second element. For example, an electric motor and an associated current supply may be provided, wherein the electric motor may be adapted to rotate the first element in relation to the second element about the vertical axis. The shape of the second element may be round in the vertical plane of the vertical axis. The first element may have the shapes described above. The rotation may have a predetermined speed. The rotation may be made by a predetermined angle. Alternatively, the rotation may orient the drinking vessel 200 in a certain direction. For example, the drinking vessel 200 may be provided with a marker and the electric motor may be controlled in such a way that the first element is rotated in relation to the second element in such a way that the marker reaches a predetermined position. For example, the drinking vessel 200 may comprise an optical marker or an inductive marker. Correspondingly, the control of the electric motor may receive signals from one or more sensors which are adapted to detect the optical marker and/or the inductive marker.

In addition, the placement device 300 may be provided with a loudspeaker or a device for producing noise. For example, a signal tone or a noise may be produced when the drinking vessel 200 is put down and/or lifted. For this purpose, the control of the loudspeaker or the device for producing noise may receive signals from the detection device. For example, an appropriate acoustical indication may be produced when a full drinking vessel 200 is put down. When the drinking vessel 200 is empty, an appropriate acoustical indication may likewise be produced. For example, an indication may be a spoken word. Alternatively, a signal tone or a number of signal tones, e.g. a siren, may sound.

The placement device 300 may also comprise a vibration mode. For this purpose, the placement device may be equipped with a vibration generator. The control of the vibration generator may receive e.g. signals from the detection device. For example, the vibration generator may be vibrated when the drinking vessel 200 is placed on the placement device 300. The vibration may be made so as to mix a beverage in the drinking vessel 200. For example, a mixed beverage may be mixed by the activation of the vibration mode. The vibration mode may take a predetermined period of time. The vibration mode may be activated in a number of successive intervals.

The placement device 300 may have a temperature sensor. The temperature sensor may be adapted to determine the temperature of the drinking vessel 200 and/or the temperature of the beverage in the drinking vessel 200. The temperature sensor may be connected to the control or controls of the above described loudspeaker and/or of the above described device for producing noise and/or of the vibration generator, as shown in FIG. 4. For example, the temperature sensor may provide a measured temperature, e.g. in the form of transmitted signals. Alternatively or additionally, the temperature sensor may also be connected to the display element or a control of the display element. Then, the above described mechanisms serve for indicating the temperature and/or when a predetermined temperature exceeds or drops below a predetermined value.

For example, an informational or warning signal may be generated when the temperature exceeds or drops below a predetermined value. For example, the color of the light emitted by the display element may be changed depending on the temperature, e.g. from a first color to a second color, e.g. from red for warm to blue for cold. When the temperature exceeds or drops below a predetermined value, the display element may flash with a predetermined frequency or emit a beep. For example, when the temperature exceeds a predetermined maximum temperature, the red light may be emitted at predetermined intervals, i.e., the placement device 300 flashes red. Correspondingly, the placement device 300 may flash blue when the temperature drops below a predetermined minimum value. The placement device 300 may give red light between these two states when the temperature drops below the maximum value, wherein the red color changes gradually, i.e., continuously or in discrete steps, into blue color when the temperature continuous to drop and starts flashing blue when the temperature drops below the minimum value. When the temperature rises, this process may be reversed.

The same process may also be controlled on the basis of the filling amount of the drinking vessel 200 instead of on the basis of the temperature. In this case, it is not the temperature that exceeds and/or drops below a maximum and/or minimum value but the filling amount that exceeds and/or drops below a maximum and/or minimum value, wherein the colors red and blue may be replaced with other colors and/or be interchanged. This means that when the drinking vessel 200 is placed on the placement device 300, the placement device 300 and/or the display element may give light in a first color, e.g. in blue. When the filling amount of the drinking vessel 200 is reduced, the blue color may change gradually, i.e., continuously or in discrete steps, into a red color. If the drinking vessel 200 is empty, the placement device 300 may give light or flash in a predetermined color. For example, the placement device 300 may flash red. When the drinking vessel 200 is lifted from the placement device, e.g. for the purpose of drinking, the placement device may give light in another predetermined color. For example, the placement device may give white light.

The light of the placement device 300 may be produced by the display element, e.g. by lamps or illuminants, such as LEDs, provided in the display element. The placement device 300 may be made of a transparent or semi-transparent material, and therefore light may escape from the surface of the placement device 300. The material may be made such that the light spreads diffusely in the placement device 300. When the placement device 300 is made of several pieces, each element or each combination of elements may be made as described above.

The placement device 300 may also comprise a communication unit. For example, the placement device 300 may comprise a radio module that may emit signals. The communication unit may be adapted to emit signals which indicate the filling level of the drinking vessel 200. In addition, the signals may also show where the placement device 300 is located. For example, the placement device 300 may be placed on a table which is provided with an active or passive marker that clearly identifies the table. For example, the table may be provided with an RFID chip. The RFID chip may comprise an identification of the table which may be read from the placement device 300. This identification of the table may then be provided by the communication unit, e.g. a display device 1100, as described in connection with FIG. 5. In addition, an RFID chip may be provided which produces a suitable signal when the placement device 300 is removed from the identified table. Said signal induces the placement device 300 to emit signals as described above. For example, the placement device may emit an acoustic or optical signal when it is removed from the table. As a result, the placement devices 300 cannot be stolen.

The placement device 300 may also include a watch. Furthermore, the surface of the placement device 300 may have an at least partially anti-bacterial effect. The placement device 300 may also be adapted to cool the liquid in the drinking vessel 200.

FIG. 5 shows a schematic drawing of a system 1000 for indicating the filling levels of several drinking vessels 200. The system 1000 comprises one or more placement devices, wherein at least one drinking vessel 200 may be placed on every placement device. Furthermore, the system 1000 may comprise a display device 1100 which displays the filling level of at least one drinking vessel 200. The display device 1100 may comprise a digital display which displays a current filling level for each drinking vessel. The display device 1100 may be provided on the at least one placement device or separately therefrom.

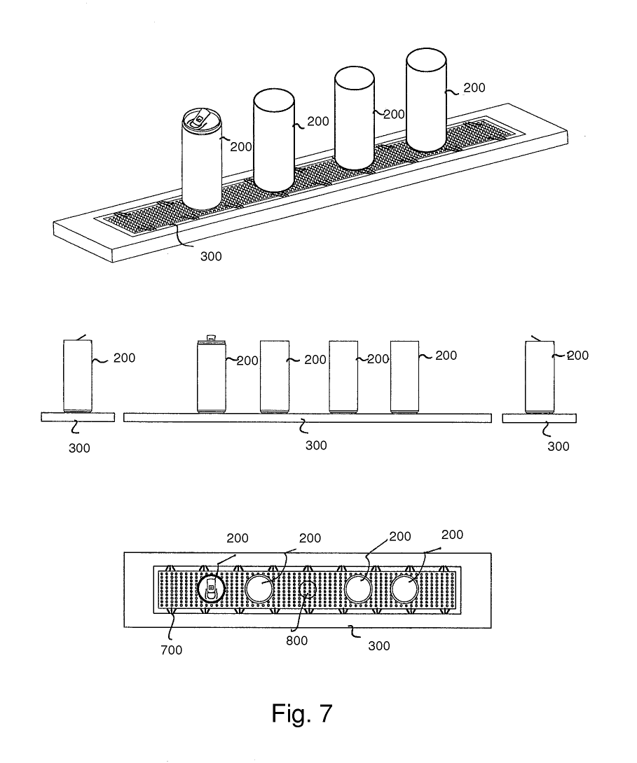

Alternatively or additionally to the display of the filling level, the system 1000 may be adapted to display whether one or more drinking vessels 200 have been placed on one or on several placement devices 300. For this purpose, the system 1000 may comprise a beverage table mat, such as a bar runner or a bar mat, as shown in FIGS. 6 and 7. The bar mat 300 may be semi-transparent. The bar mat 300 may serve as a placement device 300. The bar mat 300 may be rectangular and be made of silicone. The bar mat may comprise a pressure sensor 800 and/or a detection device. The pressure sensor 800 and/or the detection device may be arranged centrally. The bar mat 300 may comprise several illuminants 700, such as LEDs. The LEDs 700 may be arranged along the outer edge of the bar mat 300. The LEDs 700 may emit light substantially in the direction of the center line of the bar mat 300. The LEDs 700 may be oriented at right angles to the edge or at another angle to the edge, e.g. at an angle of 45° to the edge of the bar mat 300. The LEDs 700 may be arranged on two or more sides of the bar mat 300 in such a way that two LEDs 700 each are in opposite position to each other. Alternatively, the LEDs 700 arranged on two opposite sides may be displaced with respect to one another, namely by half the distance between two LEDs 700 on one side of the bar mat 300, for example. When the LEDs 700 have a light emission aperture angle of substantially 45° or when the bar mat 300 is made of a material that is transparent or semi-transparent and that produces a diffuse light which spreads with an aperture angle of substantially 45° in the bar mat 300 and/or in the transparent and/or semi-transparent part of the bar mat 300, a homogeneous illumination is achieved by the above described displacement of the LEDs 700 arranged on two opposite sides. The LEDs 700 may have a housing size of substantially 5 millimeters and a luminous intensity of 12000 mcd.

The pressure sensor 800 may be adapted to activate the LEDs 700 when a predetermined pressure is exceeded, e.g. when a drinking vessel 200 is placed on the pressure sensor 800. The bar mat 300 may be provided with accumulators or batteries 900. The accumulators 900 may be rechargeable, e.g. the accumulators may be rechargeable by kinetic energy. For example, the bar mat 300 may include five 1.2 volts/4500 mA batteries 900 which are provided on two ends of the bar mat 300. The accumulators or batteries 900 may be encased by the material of the bar mat 300. The bar mat 300 may be made without exposed contacts. The batteries 900 may be exchangeable. The bar mat 300 may have an electrical output via which the batteries 900 may be charged. The bar mat 300 may have a length of substantially 715 millimeters and a width of substantially 142 millimeters. The bar mat 300 may have a height of substantially 23 millimeters. The bar mat 300 may contain synthetic material and/or aluminum or may consist of synthetic material or aluminum. The bar mat 300 may be made of transparent or semi-transparent silicone. The bar mat 300 may have an ON/OFF switch and may automatically switch off after an inactivity of its components for a predetermined period of time, e.g. 60 minutes.

It should be noted that the description and the figures only illustrate the principles of the proposed invention. In this connection, it is clear that a person skilled in the art may use the description to derive numerous subject matters which, although not explicitly described herein, embody the principles of the proposed invention and have to be regarded as part of this disclosure. In addition, all herein mentioned principles, aspects and embodiments as well as subject matters and specific examples directed thereto shall comprise all equivalents thereof.

Finally, it should be noted that all examples described herein are only listed for educational purposes to facilitate for the reader the understanding of the principles of the proposed methods and subject matters and the inventors' concepts enriching the state of the art and they should be comprehended in such a way that specifically described examples and circumstances do not display a confining effect.

1. An apparatus for displaying the filling level of a drinking vessel, wherein the apparatus comprises:
a placement element on which the drinking vessel may be placed;
a detection element for detecting the filling level of the drinking vessel; and
a display element which displays the detected filling level.

2. The apparatus according to claim 1, wherein the display element displays the filling level of the drinking vessel by means of a light source.

3. The apparatus according to claim 2, wherein at least one of the brightness, color, and flashing frequency of the light from the light source is changed according to the filling level of the drinking vessel.

4. The apparatus according to claim 1, wherein the detection element is adapted to detect a current weight of the drinking vessel and to determine the filling level of the drinking vessel from the detected current weight of the drinking vessel and a weight of the drinking vessel in an unfilled state and a weight of the drinking vessel in a fully filled state.

5. The apparatus according to claim 4, wherein the detection element comprises a balance which is adapted to detect the current weight of the drinking vessel.

6. The apparatus according to claim 5, wherein the balance comprises a strain gauge, and the strain gauge is adapted to determine a distortion of a bending element of the balance on which the strain gauge is provided.

7. The apparatus according to claim 1, wherein the drinking vessel is made of a material that conducts electric current and the detection element is adapted to identify an electric current flow through the drinking vessel.

8. The apparatus according to claim 1, wherein the detection element is adapted to detect ultrasonic waves which are scattered by a liquid in the drinking vessel.

9. The apparatus according to claim 1, wherein the drinking vessel comprises a transparent material and the detection element is adapted to detect light which is scattered by a liquid in the drinking vessel.

10. The apparatus according to claim 1, wherein the apparatus comprises an electric energy storage and a charging element, wherein the charging element is adapted to obtain electrical energy from the placement process and to supply it to the energy storage.

11. The apparatus according to claim 1, wherein the apparatus comprises a wireless transmitter, wherein the transmitter is adapted to receive information from the detection element and transmit it.

12. The apparatus according to claim 1, wherein the placement element comprises means for centering the drinking vessel.

13. The apparatus according to claim 1, wherein incoming calls to a cell phone to which the apparatus is assigned are signalized by flashing of the apparatus.

14. An apparatus for detecting a drinking vessel, wherein the apparatus comprises:
a placement element on which the drinking vessel is placed, and
a display element which displays whether the drinking vessel is placed on the placement element.

15. A system comprising:
a plurality of placement elements for placing drinking vessels;
a plurality of detection elements for detecting the filling level of at least one of the drinking vessels; and
a display element;
wherein the display element is adapted to receive signals from the plurality of detection elements and to display the filling level of the at least one drinking vessel.

16. The system according to claim 15, wherein a detection element is adapted to detect a current weight of the drinking vessel and to determine the filling level of the drinking vessel from the detected current weight of the drinking vessel.

17. The system according to claim 15, wherein the placement element comprises means for centering the drinking vessels.

18. A drinking vessel table mat comprising:
a body, wherein the body consists of an at least partially transparent material; and
a plurality of illuminants, wherein the illuminants are attached to the body in such a way that at least part of the light emitted by the illuminants shines through the partially transparent material of the body,
wherein the emission of light by the illuminants is controlled by a pressure sensor provided on the drinking vessel table mat.

19. The drinking vessel table mat of claim 18, wherein the emission of light by the illuminants is controlled by the pressure sensor so as to indicate a filling level of a drinking vessel that is placed on the drinking vessel table mat.

20. The drinking vessel table mat of claim 18, further comprising means for centering drinking vessels on the table mat.
